(19) United States
(12) Patent Application Publication
(10) Pub. No.: US 2019/0006778 A1
(43) Pub. Date: Jan. 3, 2019

(54) Miniaturized High-Speed Plug-In Card Type Connector

(71) Applicant: Amphenol Commercial Products (ChengDu) Co.LTD, Chengdu (CN)

(72) Inventors: Jun Fan, Suining (CN); Rongzhe Guo, Chengdu (CN)

(73) Assignee: Amphenol Commercial Products (ChengDu) Co.LTD, Chengdu (CN)

(21) Appl. No.: 15/878,426

(22) Filed: Jan. 24, 2018

(30) Foreign Application Priority Data
Jun. 28, 2017 (CN) 2017207615379
Sep. 12, 2017 (CN) 2017211594303

(51) Int. Cl. H01R 12/72; H01R 13/6461; H01R 13/50; H01R 13/422

(52) U.S. Cl. CPC H01R 12/721; H01R 13/422; H01R 13/50; H01R 13/6461

(57) ABSTRACT

A miniaturized high-speed plug-in card type connector, including a plastic shell. Two rows of signal terminals, which are arranged in a staggered manner, are arranged in the plastic shell. Where in the two rows of signal terminals are arranged in a staggered manner. The distance between the two adjacent signal terminals in the same row is 0.62-0.68 mm. Each signal terminal includes a terminal body and a head end connected as a whole with the terminal body, and a thickness of the head end is smaller than a thickness of the terminal body.

### CROSS REFERENCE TO RELATED APPLICATIONS

This application is based upon and claims priority to Chinese Patent Application No. 2017207615379, filed on Jun. 28, 2017 and Chinese Patent Application No. 2017211594303 filed on Sep. 12, 2017, the entire contents of which are incorporated herein by reference.

### TECHNICAL FIELD

The present invention relates to the technical field of communication, and particularly relates to a miniaturized high-speed plug-in card type connector.

### BACKGROUND OF THE INVENTION

In order to carry the electronic products, it is desirable for the electronic products to be made portable. A partial volume of the electronic product can be optimized by adjusting the mounting distances among internal components. However, for connectors in which signal transmission or power supply transmission is performed, their structures themselves are small. If the structures are further reduced, large crosstalk may be caused during signal transmission, which is counterproductive. Thus, the miniaturized design of the connectors causes some trouble to the miniaturization of the electronic products.

### SUMMARY OF THE INVENTION

In view of the above-discussed deficiencies of the prior art, the present invention provides a miniaturization high-speed plug-in card type connector, which can ensure normal signal transmission while the volume of the connector is reduced.

To fulfill the above objective, the present invention adopts the below technical solutions.

A miniaturized high-speed plug-in card type connector is provided, including a plastic shell. Two rows of signal terminals, which are arranged in a staggered manner, are arranged in the plastic shell. The distance between the two adjacent signal terminals in the same row is 0.62-0.68 mm.

Further, each signal terminal includes a terminal body, and a head end connected as a whole with the terminal body, and a thickness of the head end is smaller than a thickness of the terminal body.

Further, the plastic shell is formed integrally with the two rows of signal terminals by an injection molding mode.

Further, the plastic shell is provided with a terminal clamping groove extending through a bottom of the plastic shell, and the signal terminals are installed in the terminal clamping groove.

Further, the terminal body includes an extending portion, a connecting portion, a plane portion and an arc-shaped portion, wherein the extending portion, the connecting portion, the plane portion and the arc-shaped portion are integrally connected, wherein the extending portion is located outside the terminal clamping groove, and an included angle is formed between the connecting portion and the extending portion.

Further, the connecting portion is substantially perpendicular to the extending portion.

Further, arc-shaped grooves are respectively formed on the two sides of the connecting portion.

Further, two ends of the plastic shell are each provided with a clamping groove, and a fixing terminal is installed in the clamping groove.

Further, the fixing terminal and the clamping groove are both T-shaped. A connecting hole is formed in a vertical plate of the fixed terminal, and the connecting hole is located outside the clamping groove.

Further, at least one guide column is arranged at the bottom of the plastic shell.

Advantages of the present invention are provided below. According to the solutions, the spacing between two adjacent signal terminals in the same row is reduced from previously 0.8 mm to the range of 0.62-0.68 mm, so that the length of the connector is greatly reduced to achieve the miniaturization of the connector. While the volume of the entire connector is reduced, the signal terminals are arranged in a staggered manner, so that the original two opposite rows of signal terminals are staggered by a certain distance. Accordingly, the spacing between the two opposite rows of terminals is increased to improve the SI performance of connector, further reducing the signal crosstalk.

### BRIEF DESCRIPTION OF THE DRAWINGS

FIG. 1 is an exploded view of the miniaturization high-speed plug-in card type connector.

FIG. 2 is an enlarged view of part B.

FIG. 3 is a top view of the miniaturized high-speed plug-in card type connector.

FIG. 4 is an enlarged view of part A.

FIG. 5 is a front view of the miniaturized high-speed plug-in card type connector.

FIG. 6 is a perspective view of a signal terminal.

In figures: 1. plastic housing; 11. clamping groove; 12. terminal clamping groove; 13. connecting plate; 14. guide column; 2. fixing terminal; 3. signal terminal; 31. extending portion; 32. connecting portion; 33. plane portion; 34. arc-shaped portion 35. terminal body; 36. head end.

### DETAILED DESCRIPTION OF THE INVENTION

The embodiments of the present invention are described below, so that the person skilled in the art can understand the present invention. However, it should be clear that the present invention is not limited to the scope of the specific embodiments. For the persons skilled in the art, so long as various changes are within the spirit and scope of the present invention as defined and determined by the appended claims, these changes are obvious. All the inventions utilizing the inventive concepts of the present invention fall into the protection scope of the present invention.

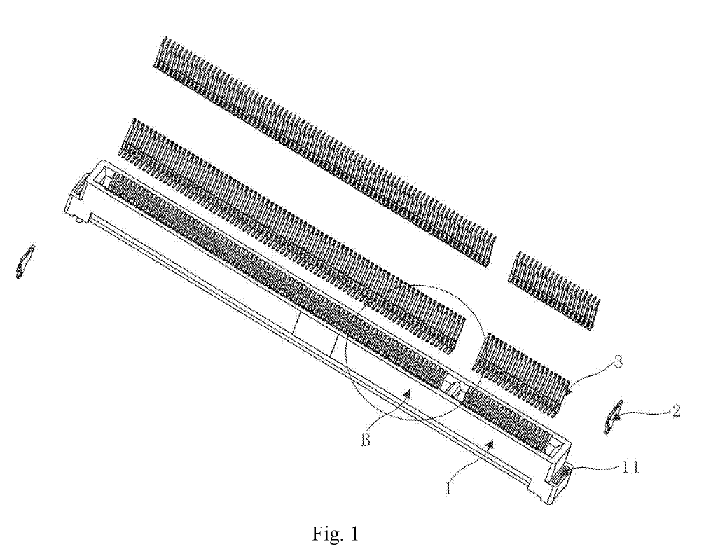

As shown in FIGS. 1-6, the miniaturized high-speed plug-in card type connector includes a plastic shell 1. Two rows of signal terminals 3 which are arranged in a staggered manner are arranged in the plastic shell 1. where in the two rows of signal terminals 3 are arranged in a staggered manner. The signal terminals 3 are arranged in a staggered mode. Therefore, the distance between two rows of opposite terminals can be increased, so that the SI performance of the connector is improved.

The distance between two adjacent signal terminals 3 in the same row is 0.62-0.68 mm. According to the technical solution, the distance between every two adjacent signal terminals 3 is reduced from previously 0.8 mm to the range of 0.62-0.68 mm, thus greatly reducing the length of the connector.

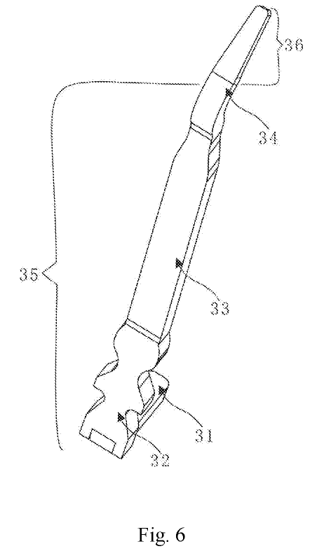

As shown in FIG. 6, the signal terminal 3 includes a terminal body 35, and a head end 36 connected as a whole with the terminal body 35. The thickness of the head end 36 is smaller than that of the terminal body 35. By improving the thickness of the signal terminal, the SI performance of the connector can be improved.

The two rows of signal terminals 3 are arranged in the plastic shell 1, and a PCB inserting groove is formed between the two rows of signal terminals 3. When using the connector, the PCB inserting groove is used for installing a PCB (printed circuit board) in a card inserting mode. One end, away from the head end 36, of the signal terminal 3 is connected to another PCB through a welding mode.

In one embodiment of the present invention, in order to facilitate assembly of the signal terminal 3 and the plastic housing 1, the two rows of signal terminals 3 can be arranged in a staggered manner and then placed into an injection mold. The plastic shell 1 is formed outside the signal terminal 3 by an injection molding mode. The plastic shell 1 and the signal terminal 3 are assembled together in this mode, then the signal terminals 3 can be avoided to be installed one by one, solving the problem of time-consuming installation.

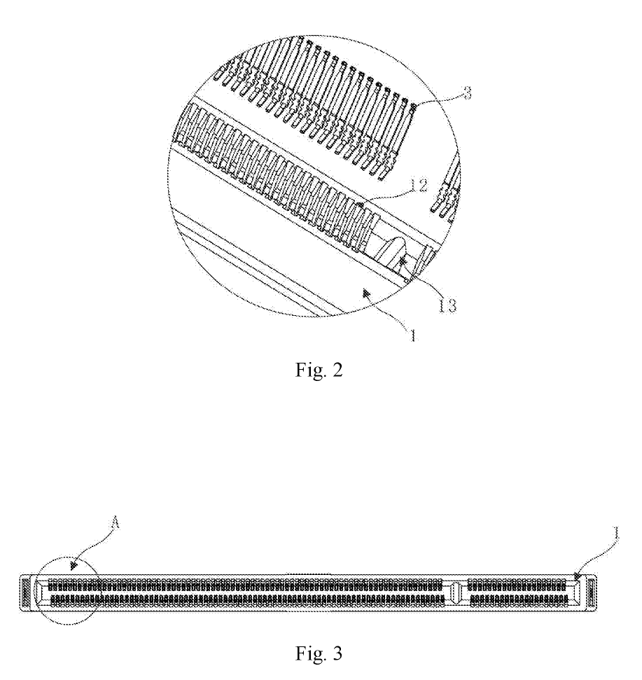

Referring to FIG. 1, an exploded view of a miniaturized high-speed plug-in card type connector is shown in FIG. 1. FIG. 2 shows an enlarged view of the portion B in FIG. 1. As shown in FIG. 1 and FIG. 2, the plastic shell 1 is provided with a terminal clamping groove 12 extending through the bottom of the plastic shell 1. The signal terminals 3 are installed in the terminal clamping groove 12. The signal terminals are installed in this mode, even though the installation is time-consuming, once one signal terminal 3 is damaged, the replacement can be facilitated. In addition, the customer can install different types of signal terminals 3 according to needs.

As shown in FIG. 6, the terminal body 35 includes an extending portion 31, a connecting portion 32 (the arc-shaped grooves are respectively formed in the two sides of the connecting portion 32), a plane portion 33 and an arc-shaped portion 34, and the extending portion 31, the connecting portion 32, the plane portion 33 and the arc-shaped portion 34 are integrally connected. The extending portion 31 is located outside the terminal clamping groove 12, and an included angle is formed between the connecting portion 32 and the extending portion 31. That is to say, the extending portion 31 and the connecting portion 32 can be arranged in a substantially perpendicular manner. For example, a small space may be occupied when the device is installed in a range of 85 degrees to 95 degrees.

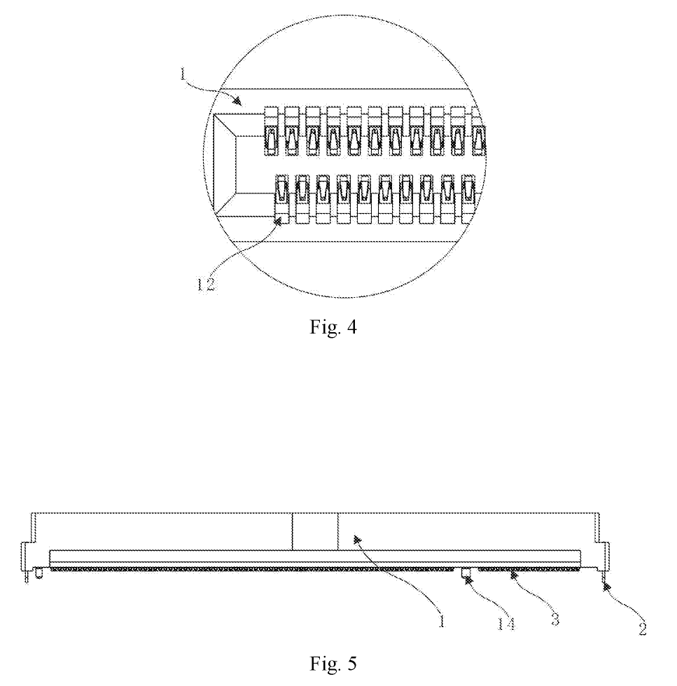

As shown in FIG. 5, to enable the extension part 31 to be tightly attached to the bottom of the plastic shell 1, after the signal terminals 3 are positioned on the plastic housing 1, so as to ensure the feasibility of miniaturization of the connector, in the technical solution, the connecting portion 32 is preferably perpendicular to the extending portion 31.

The arc-shaped portion 34 and the head end 36 are connected into a whole, so that an included angle is formed between the arc-shaped portion 34 and the head end 36. The distance between the two rows of opposite signal terminals 3 can be increased through this unique arrangement of the structure, and the crosstalk of the signals is further reduced. In addition, when the signal terminals 3 with this structure are adopted, then the original signals can still be transmitted while the volume of the signal terminals 3 is reduced, so that the length of the connector is further reduced.

As shown in FIG. 1 and FIG. 2, in an implementation, a connecting plate 13 which is fixedly connected to the side wall of the plastic shell 1, is arranged at the position, where the signal terminals 3 are not provided on the two sides of the PCB inserting groove. The strength of the plastic shell 1 can be increased with the arrangement of the connecting plate 13, so that the deformation of the long plastic shell 1 in use can be avoided.

In one embodiment of the present invention, a clamping groove 11 is formed in each of two ends of the plastic housing 11, and a fixing terminal 2 is clamped in the clamping groove 11. As shown in FIG. 1 and FIG. 5, the fixing terminal 2 and the clamping groove 11 are both T-shaped. A connecting hole is formed in the vertical plate of the fixed terminal 2, and the connecting hole is located outside the clamping groove 11. Due to the arrangement of the connecting hole, the connector can be stably fixed on other components (such as a PCB). The connecting hole is preferably a round hole.

As shown in FIG. 5, in order to ensure that the connector is accurately installed on other components, at least one guide column 1414 can be arranged at the bottom of the plastic shell 11.

In conclusion, according to the technical solution, the position, the distance between the signal terminals 3, and the thickness of the head end 36 of the signal terminal 3 are uniquely arranged, normal signal transmission can still be guaranteed while the size of the connector is reduced.

I claim:

1. A miniaturized high-speed plug-in card type connector, comprising:
a plastic shell;
two rows of signal terminals arranged in the plastic shell, where in the two rows of signal terminals are arranged in a staggered manner,
and the distance between the two adjacent signal terminals in the same row is 0.62-0.68 mm.

2. The miniaturized high-speed plug-in card type connector of claim 1, wherein each signal terminal includes a terminal body, and a head end connected as a whole with the terminal body, and a thickness of the head end is smaller than a thickness of the terminal body.

3. The miniaturized high-speed plug-in card type connector of claim 1, wherein the plastic shell is formed integrally with the two rows of signal terminals by an injection molding mode.

4. The miniaturized high-speed plug-in card type connector of claim 1, wherein the plastic shell is provided with a terminal clamping groove extending through a bottom of the plastic shell, and the signal terminals are installed in the terminal clamping groove.

5. The miniaturized high-speed plug-in card type connector of claim 2, where in the terminal body includes an extending portion, a connecting portion, a plane portion and an arc-shaped portion, wherein the extending portion, the connecting portion, the plane portion, and the arc-shaped portion are integrally connected, wherein the extending portion is located outside the terminal clamping groove, and an included angle is formed between the connecting portion and the extending portion.

6. The miniaturized high-speed plug-in card type connector of claim 5, wherein the connecting portion is substantially perpendicular to the extending portion.

7. The miniaturized high-speed plug-in card type connector of claim 5, wherein arc-shaped grooves are respectively formed on the two sides of the connecting portion.

8. The miniaturized high-speed plug-in card type connector of claim 1, wherein two ends of the plastic shell are each provided with a clamping groove, and a fixing terminal is installed in the clamping groove.

9. The miniaturized high-speed plug-in card type connector of claim 8, wherein the fixing terminal and the clamping groove are both T-shaped, wherein a connecting hole is formed in a vertical plate of the fixed terminal, and the connecting hole is located outside the clamping groove.
